(19) United States
(12) Patent Application Publication
(10) Pub. No.: US 2012/0313577 A1
(43) Pub. Date: Dec. 13, 2012

(54) SYSTEM AND METHOD FOR DETECTING, CHARACTERIZING, AND TRACKING AN INDUCTIVE POWER RECEIVER

(75) Inventors: Benjamin C. Moes, Wyoming, MI (US); David W. Baarman, Fennville, MI (US)

(73) Assignee: ACCESS BUSINESS GROUP INTERNATIONAL LLC, Ada, MI (US)

(21) Appl. No.: 13/492,082

(22) Filed: Jun. 8, 2012

Related U.S. Application Data
(60) Provisional application No. 61/495,558, filed on Jun. 10, 2011.

(51) Int. Cl. H02J 7/00

(52) U.S. Cl. 320/108

(57) ABSTRACT

A system and method for detecting, characterizing, and tracking an inductive power receiver proximate to an inductive charging surface of an inductive charger. One or more resonators and one or more sensors provide information that can be utilized to detect, characterize, and track the inductive power receiver. The resonators can be configured to determine position of a remote device using magnitude or phase of sensors associated with resonators. In addition, by monitoring the inductive power transmitter and the resonators, the charger can differentiate between whether parasitic metal is present, a remote device is present, or both are present.

### BACKGROUND OF THE INVENTION

An inductive power supply, sometimes referred to as an inductive charger, may be used to supply wireless power to power or charge secondary devices. In some known inductive power supplies, secondary devices are powered or charged by placing them on a charging surface. Some inductive power supplies limit spatial freedom by requiring specific placement and orientation of the remote device with respect to the inductive power supply.

In some known inductive power supply systems, a single primary coil is embedded in a charging surface of a charging device and a single secondary coil is embedded in a secondary device. Power can be provided from a mains input to the charging device, sometimes referred to as a wireless power supply. Assuming the mains input provides AC power, the power can be rectified in a mains rectification circuit into DC power and then can be adjusted in a DC/DC power supply. An inverter can switch the DC power at a frequency controlled by the controller in order to generate an AC signal across the inductive tank circuit to produce an electromagnetic field. The tank circuit can include a primary coil and a primary capacitor. The secondary device can include a secondary coil and an optional resonant capacitor to receive the electromagnetic energy. Once received on the secondary device, the AC signal can be rectified into DC power in a rectification circuit. From there, the DC power can directly power the load, or where the load is a battery the power can be used to charge the battery. A controller may be utilized to control how the power is applied to the load or to control a charging algorithm for charging a battery. In this type of system, power transfer efficiency is typically increased when the coils are aligned center to center, and when the spacing between the primary and secondary coils is reduced. However, this requirement of close one-to-one alignment in order to effectively communicate and transmit power restricts spatial freedom and limits the charger to operation with one secondary device at a time. To enable a surface with wireless power, the user is typically provided with information about where the device needs to be located. This can be done with a magnetic alignment feature, or with different mechanical guides that force devices to be placed in a certain place, or with graphical elements that guide the user to correctly place the device. Some users would like more freedom to move the secondary device around on the surface of the charging device.

One inductive charger provides an array of coils arranged adjacently in a single layer. In this solution, a number of primary coils are disposed in an array near the charging surface. Other inductive chargers provide a multi-layer coil array. By having two or more layers of coils arranged such that the center of a winding pattern on one layer is placed on the gap between adjacent winding patterns on another layer, additional spatial freedom can be provided.

Some inductive chargers energize all of the coils in the array so that no matter where the device is placed on the array, it can receive energy from the charger. Some array solutions attempt to circumvent having to turn on a large amount of coils by providing magnetic attractors to specifically locate the device on a charging surface so that power can be transferred utilizing a single coil. However, magnetic attractors add cost, complexity, and can lower efficiency of the power transfer system. Various ergonomic alignment solutions have also been proposed, but these aids can disrupt the aesthetics of surfaces, add complexity to the design of the surface, and can affect the usability because alignment still may not be guaranteed.

### SUMMARY OF THE INVENTION

The present invention provides a system and method for detecting, characterizing, and tracking an inductive power receiver proximate to an inductive charging surface of an inductive charger. The inductive charger includes one or more inductive power transmitters for transferring power to an inductive power receiver located proximate to the inductive charging surface. The inductive charger also includes one or more resonators and one or more sensors that provide information that can be utilized to detect, characterize, and track the inductive power receiver.

The one or more resonators can be configured such that 1) in the absence of an inductive power receiver, driving the inductive power transmitter does not produce a significant change in current in the one or more resonators; and 2) in the presence of an inductive power receiver, driving the inductive power transmitter does produce a significant change in current in one or more resonators. In one embodiment, the one or more resonators are offset from the one or more inductive power transmitters such that the coupling ratio between the one or more resonators and the one or more inductive power transmitters is substantially reduced. In another embodiment, the one or more resonators are located remote from the one or more inductive power transmitters such that the coupling ratio between the one or more resonators and the one or more inductive power transmitters is substantially reduced. In another embodiment, the one or more resonators are shielded from the one or more inductive power transmitters. In yet another embodiment, the inductive charger includes a combination of offset resonators, remote resonators, and shielded resonators. In each of the embodiments, when the one or more inductive power transmitters are driven and coupled to the inductive power receiver, then the inductive power receiver couples to one or more resonators to produce a significant current.

In one embodiment, by monitoring a characteristic of power in the one or more resonators, the system can detect when an inductive power receiver has been placed proximate to the inductive charging surface because an inductive power receiver, when placed, couples to one or more resonators and induces current in the one or more resonators. However, when a piece of metal is placed proximate to the inductive charging surface, the induced currents in the metal do not perpetuate the field to the resonator. Accordingly, a resonator sensor can detect when an inductive power receiver is placed proximate to the inductive charging surface by monitoring a characteristic of power in the resonator without producing a false positive when metal is placed proximate to the inductive charging surface. Further, by monitoring a characteristic of power in the inductive power transmitter and a characteristic of power in a resonator the inductive charger can differentiate between detection of a situation where an inductive power receiver is present, metal is present, or an inductive power receiver and metal are both present.

In another embodiment, by measuring one or more characteristics of power in the one or more resonators the inductive power receiver can be characterized. Characterizing an inductive power receiver can include determining the position of the inductive power receiver, determining the boundaries of the inductive power receiver, determining the shape of the inductive power receiver, determining the size of the inductive power receiver, determining the dimensions of the inductive power receiver, determining the orientation of the inductive power receiver, and determining other characteristics about the inductive power receiver. In addition, one or more characteristics of power in the one or more inductive power transmitters can be measured and utilized in the characterization.

The position of an inductive power receiver can be determined by analyzing the magnitude of a characteristic of power in the one or more resonators. The magnitude of a characteristic of power is representative of the amount of flux penetrating the resonator from the inductive power receiver. Therefore, the closer the inductive power receiver is to a given resonator, the higher the magnitude.

In some situations, it can be difficult to determine whether the inductive power receiver is generally adjacent to or substantially overlapping a resonator. By collecting information about the phase of a characteristic of power in the one or more resonators relative to the one or more inductive power transmitters, the system can determine whether the inductive power receiver is generally adjacent to or substantially overlapping a resonator. That information can be utilized to help characterize the inductive power receiver. The phase of a characteristic of power is representative of the direction of the majority of flux penetrating the resonator from the inductive power receiver. Accordingly, where the resonator is in phase with the one or more inductive power transmitters, a majority of the inductive power receiver overlaps the resonator. Where the resonator is out of phase with the one or more inductive power transmitters, a majority of the inductive power receiver does not overlap the resonator.

The inductive charger can dynamically configure a plurality of inductors, sometimes referred to as coils, arranged in an array. Depending on how the system is configured, some inductors can be inductive power transmitters, some can be resonators, and some can be open circuit. In some embodiments, some inductors can be permanently configured as resonators or inductive power transmitters and other inductors can be dynamically configurable. By dynamically configuring the inductor array, an inductive power receiver can be quickly detected, characterized or tracked. In one embodiment, a multiplexer connects inductors to either a driver, a reference voltage, or leaves them disconnected as an open circuit. When an inductor is connected to the reference voltage, it becomes a resonator and when an inductor is connected to a driver, it becomes an inductive power transmitter.

Alternatively, the inductive charger may have a dedicated power transfer coil and use resonating coils to sense whether a remote device is properly aligned with the power transfer coil. The resonating coils may be constructed using low cost coils such as single conductor wire wound coils, surface mount inductors, or printed inductors made of PCB material. The inductive charger may use the device location information to adjust power transfer characteristics such as reducing the maximum allowable power when a device is misaligned. The inductive charger may also display information to a user about the current alignment of the remote device, such as an OLED display or simple LED array. The inductive charger may also provide alignment information to the remote device and the remote device may determine to display the alignment information to the user on a display system of the remote device. This information may be communicated through the coils as a modulated power signal, or may be communicated through an alternative data communication channel such as Bluetooth or WiFi.

In different embodiments, sensors can be located in different locations. In one embodiment, each inductor is associated with its own sensor. In an alternative embodiment one sensor is placed between the multiplexer and the driver and another sensor is placed between the multiplexer and the reference voltage.

In another alternative embodiment, two or more drivers are used so that multiple inductive power receivers can receive power simultaneously. To configure coils in the array as resonating coils, one field effect transistor of the driver is turned on and left on, to connect the coil to a reference voltage. This allows the coils to be resonating coils, but also allows multiple devices to be powered separately since two or more drivers can be connected to a fully selectable array.

In one embodiment, once the position of an inductive power receiver is known, the system can track the movement of the inductive power receiver. As the inductive power receiver moves towards or away from a resonator, coupling between the inductive power receiver and the resonator increases or decreases respectively. By periodically taking measurements for each resonator, movement of the inductive power receiver can be tracked. Further, the system can use the movement information to dynamically switch inductors between resonators, inductive power transmitters, and open circuit in order to most effectively provide power to the inductive power receiver. For example, if the current in a resonator increases to a certain level, then the inductive power receiver may have moved a distance far enough to where a new inductive power transmitter or set of inductive power transmitters should be configured and selected.

Alternatively, the inductive power receiver may optionally activate its coil to transmit power from remote device to charging base. The charging base can then analyze the characteristics of current in the transmit and resonating coils to determine remote device location.

These and other features of the invention will be more fully understood and appreciated by reference to the description of the embodiments and the drawings.

### BRIEF DESCRIPTION OF THE DRAWINGS

FIG. 1 shows a representative diagram of an inductive charger with three inductive power transmitters and one resonator, all coupled to the inductive power receiver of a secondary device.

FIG. 2 shows a three layer coil array where one coil is configured as an inductive power transmitter and three adjacent coils are configured as resonators.

FIG. 3 shows an inductive power receiver placed on the array near the inductive power transmitters and resonators.

FIG. 4 one embodiment of a portion of inductive charger circuitry where a multiplexer selectively connects one or more coils, each with a dedicated sensor, to the driver or ground.

FIG. 5 shows another embodiment of a portion of inductive charger circuitry with sensors are placed between the driver and the multiplexer, and between the reference voltage and the multiplexer.

FIG. 6 shows another embodiment of a portion of inductive charger circuitry where two drivers are connected to a multiplexer, each driver having a dedicated sensor.

FIG. 7 shows a representative three coil array where two coils are configured as resonators and one coil is configured as an inductive power transmitter.

FIG. 8 shows a portion of the circuitry for the inductive charging system where each coil has a dedicated coil driver and sensor.

FIG. 9 shows the three coil array of FIG. 7 with an inductive power receiver placed on the array.

FIG. 10 shows the three coil array of FIG. 7 with a different inductive power receiver placed on the array.

FIG. 11 shows a three layer coil array where one coil is configured as an inductive power transmitter and another coil is configured as a remote resonator.

FIG. 12 shows an inductive power receiver placed on the FIG. 11 array.

FIG. 13 shows an inductive power transmitter, receiver, and four dedicated resonators.

FIG. 14 shows the phase relationships between the transmitter and the four resonators.

FIG. 15 shows an example schematic of the embodiment shown in FIG. 14.

FIG. 16 shows an alternate schematic of the embodiment shown in FIG. 15.

FIG. 17 shows an alternate schematic of a single resonator, wherein a series resonant capacitor is provided to enhance performance.

FIG. 18. shows an inductive power transmitter and a remote device.

FIG. 19 shows a remote device being placed on the inductive power transmitter, but with its power receiving coil misaligned with the power transmitting coil of the inductive power transmitter. The LED directing the user to move the device is shown illuminated.

### DESCRIPTION OF THE CURRENT EMBODIMENT

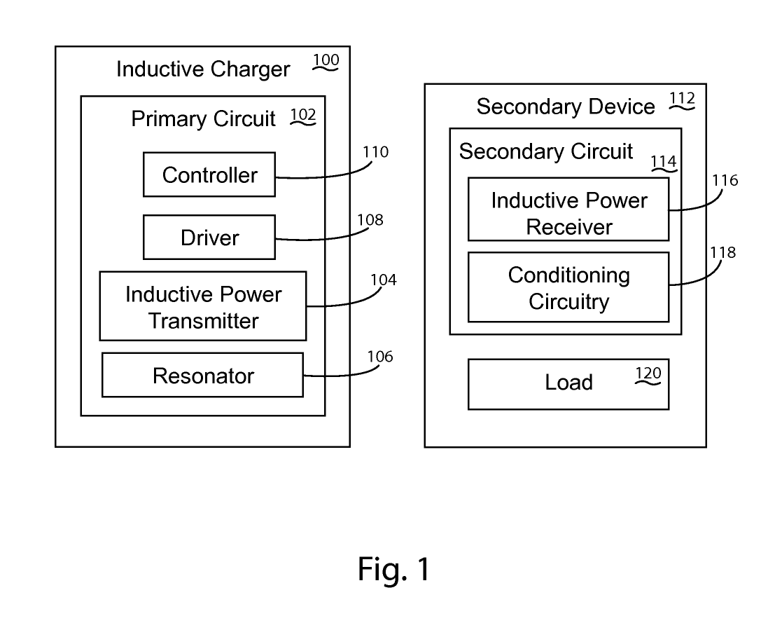

An inductive charging system in accordance with an embodiment of the present invention is shown in FIG. 1. The inductive charging system includes an inductive charger 100 that generates an electromagnetic field to wirelessly transfer power to a secondary device. The inductive charger can include various primary circuitry 102, which will be discussed in more detail below. In general, the primary circuitry can include one or more inductive power transmitters 104, one or more resonators 106, a driver 108 for energizing one or more inductive power transmitters 104, one or more sensors (not shown), and a controller 110. The secondary device 112 can include a load and various secondary circuitry 114, which will also be discussed in more detail below. Examples of secondary devices can include mobile telephones, tablets, laptops, or any other device desiring power. In general, the secondary circuitry 114 can include one or more inductive power receivers 116, a load 120, and circuitry for conditioning inductive power received by the inductive power receiver 118. Based on the sensors, the inductive charging system can at least one of detect, characterize, track, the inductive power receiver.

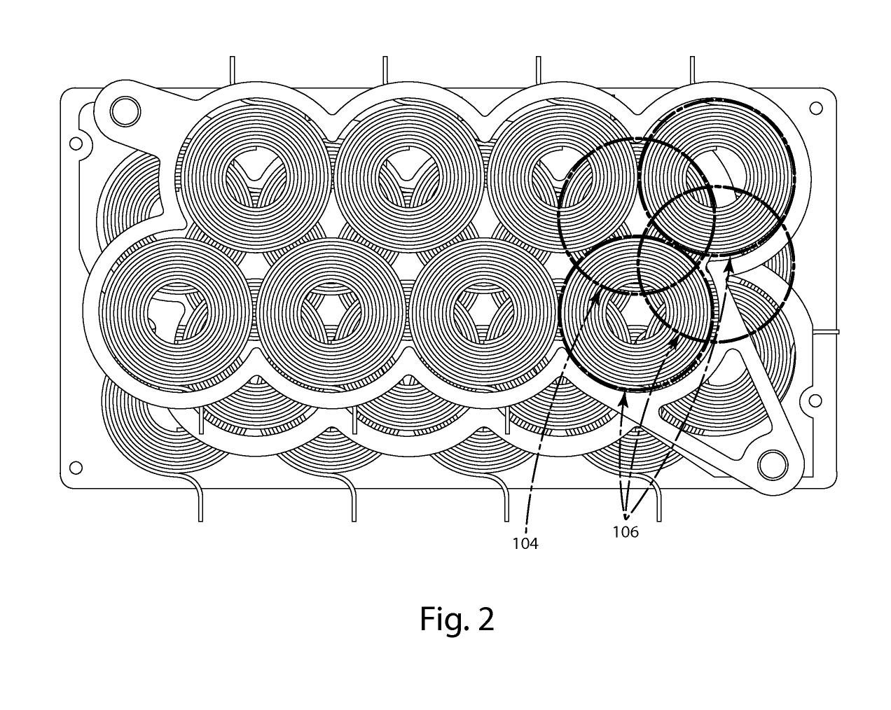

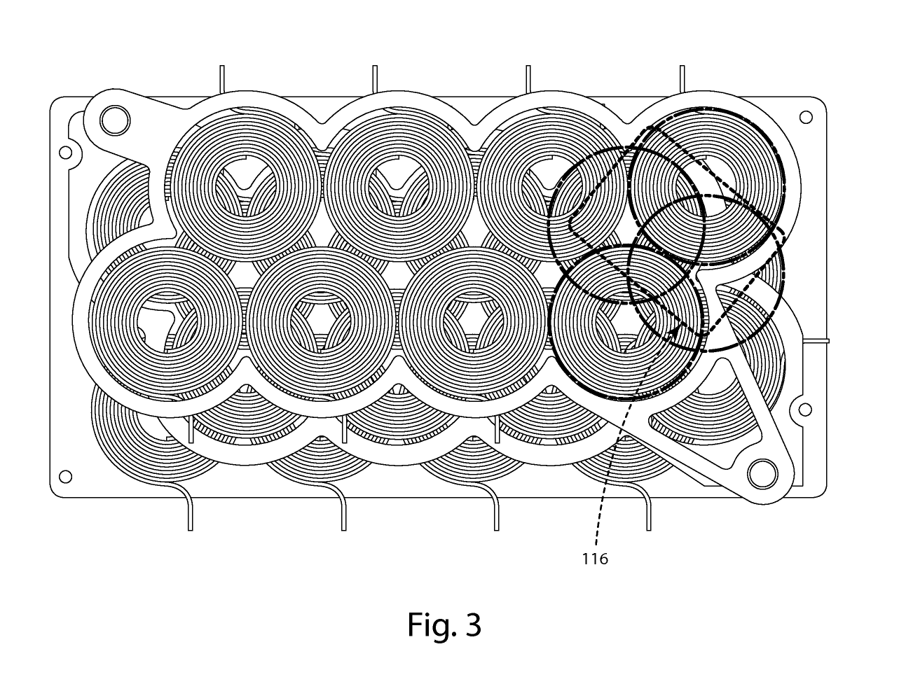

Referring to FIGS. 2-3, a coil array in accordance with an embodiment of the present invention is illustrated. Another coil array in accordance with another embodiment of the present invention is shown in FIG. 7. The coil array can be a multi-layer coil array, as discussed below, and as disclosed in detail in US Publication Patent Application No. 2010/0259217, filed on Apr. 8, 2010 to Baarman et al, which is herein incorporated by reference in its entirety. The coil array can be a counter wound coil array where two or more coaxial and spaced-apart generate a region of cooperative magnetic flux therebetween. In a counter wound coil array, the device with the inductive power receiver can be positioned proximate the region of cooperative magnetic flux to receive wireless power from the contactless power supply and the spaced-apart primary coils can be wound in alternating directions about a common axis and driven in phase, or can be wound in a single direction about a common axis and driven approximately 180 degrees out of phase from one another. The counter wound coil array is disclosed in detail in U.S. Patent Application No. 61/479,926, filed on Apr. 28, 2011 to Norconk et al, which is herein incorporated by reference.

A coil array provides a charging surface where one or more remote devices can be placed in order to receive wireless power. In FIG. 2, a multi-layer coil array is provided where each coil is offset by one radius length and arranged in a stacked configuration directly on top of one another. The coils are shown as generic donut shapes in the illustrations, which represent generally spiral coils. However, it should be understood that the coil geometry, number of turns of the winding, wire diameter and essentially any other physical property of the coil may vary depending on the application. Coils can also be referred to as windings or inductors. In alternative embodiments, the coils may be offset by a different amount. For example, in an embodiment where multiple coils are selected to be inductive power transmitters simultaneously, a different offset distance may be more appropriate. Further, in alternative embodiments, the shape and size of the array can vary depending on the desired application. For example, in alternative embodiments, the coils could be spread across a single layer or two staggered layers.

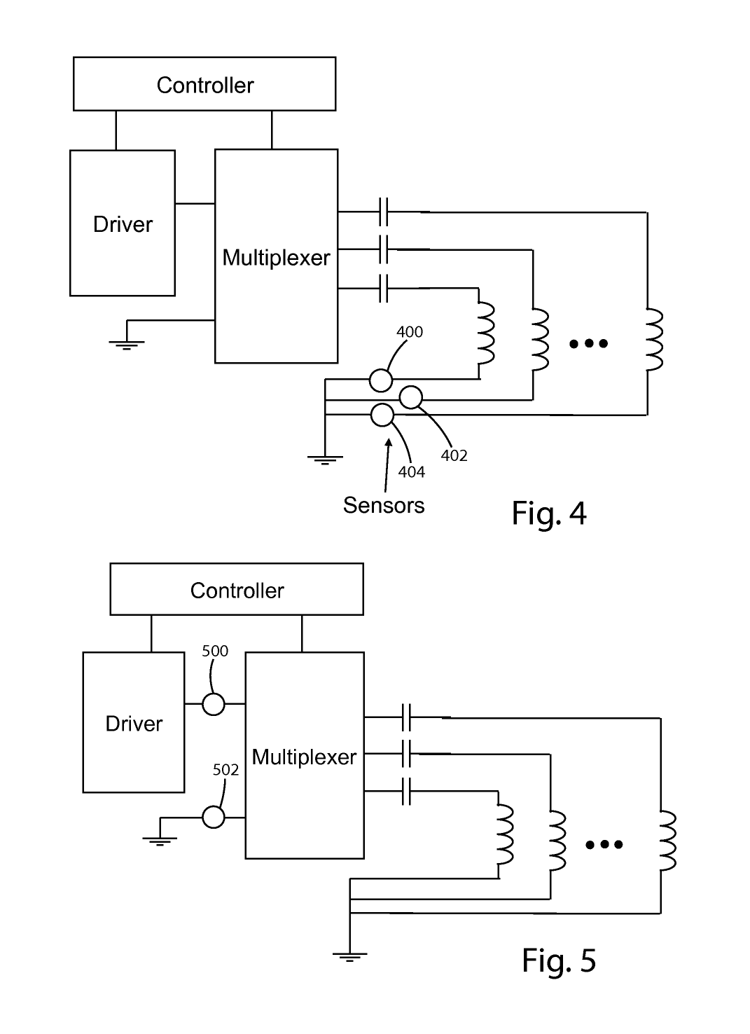

The coil array can be selectively configurable. In each of the embodiments depicted in FIGS. 4-6, the inductive charger includes a driver, a coil array, a multiplexer, and a controller programmed to selectively configure 1) one or more coils in the array to be inductive power transmitters that can be energized by a driver to transfer power contactlessly to an inductive power receiver in a device placed on the charging surface; 2) one or more coils in the array to be resonators by selectively connecting the coils to a common reference; and 3) one or more coils in the array to be in an open circuit configuration. The ability to selectively configure a coil as an inductive power transmitter or a resonator allows a secondary device can be detected, characterized, tracked, and powered across an entire charging surface.

Alternatively, the resonators may be configured as fixed resonators that may be just inductors that detect changes in coupling between a remote device and an inductive power supply. The resonators may optionally have resonant capacitors to create resonating circuits. The resonant point may be substantially near the operating frequency of the transmitter, or may substantially close to a resonant frequency of the remote device. The inductive power supply may be configured to provide alignment information to a user.

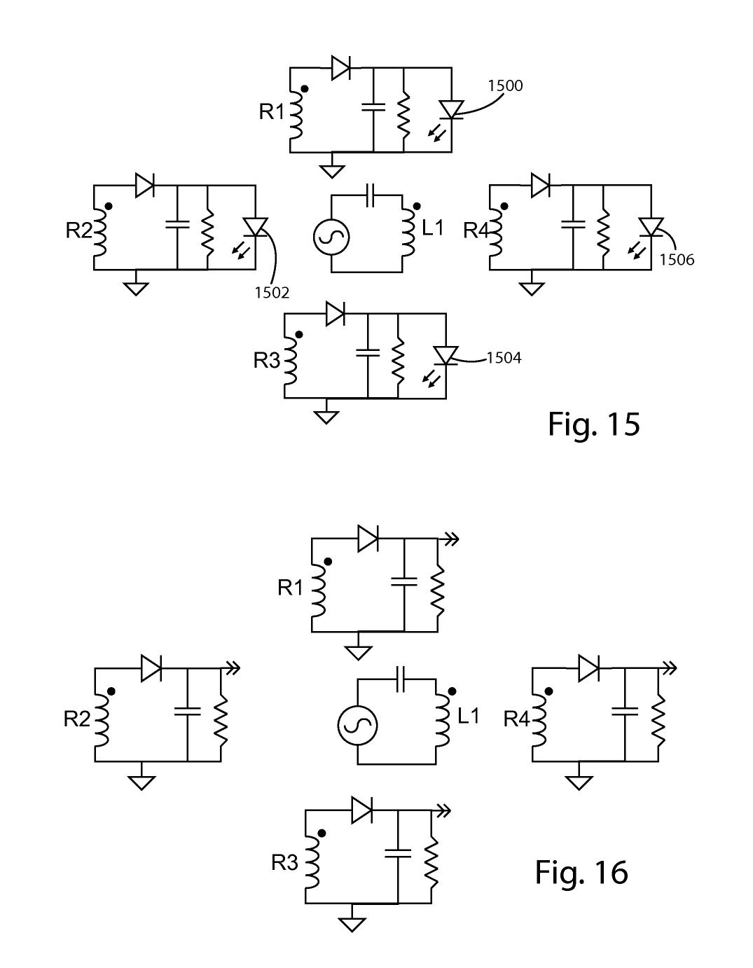

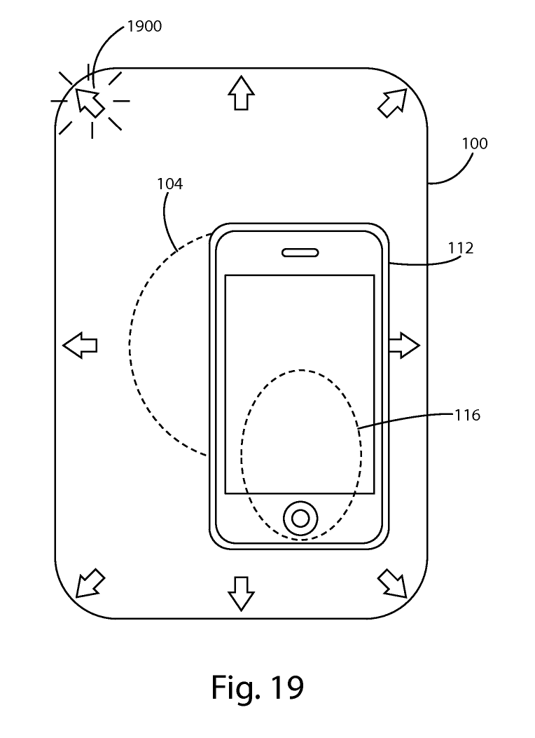

The resonators may drive LEDs 1500, 1502, 1504, 1506 through a rectifier such as the circuit shown in FIG. 15, or a microcontroller may use sensors to detect the current in the resonators and use the information to display alignment information to the user such as the circuit shown in FIG. 16. The display may be several LEDs 1800 arranged to show direction information to a user, such as the LEDs shown in FIG. 18. FIG. 19 shows a remote device 112 being placed on the inductive power transmitter 100, but with its power receiving coil 116 misaligned with the power transmitting coil 104 of the inductive power transmitter 100. The LED 1900 directing the user to move the device is shown illuminated.

Alternatively, the inductive power supply may provide alignment information to the remote device through a communication channel. This communication channel could be through modulation of the inductive power signals, a separate RF communication channel such as Bluetooth or Wifi, or an optical communication channel such as infrared.

Each resonator is configured such that 1) in the absence of an inductive power receiver coupling to the resonator, driving the inductive power transmitter does not produce a significant change in current in the resonator; and 2) in the presence of an inductive power receiver coupling to the resonator, driving the inductive power transmitter does produce a significant change in current in the resonator. This resonator configuration can be achieved in a variety of different ways, such as by offsetting the resonator from the inductive power transmitter, locating the resonator remotely from the inductive power transmitter, or shielding the resonator from the inductive power transmitter. In one embodiment, the inductive charger includes a combination of offset resonators, remote resonators, and shielded resonators.

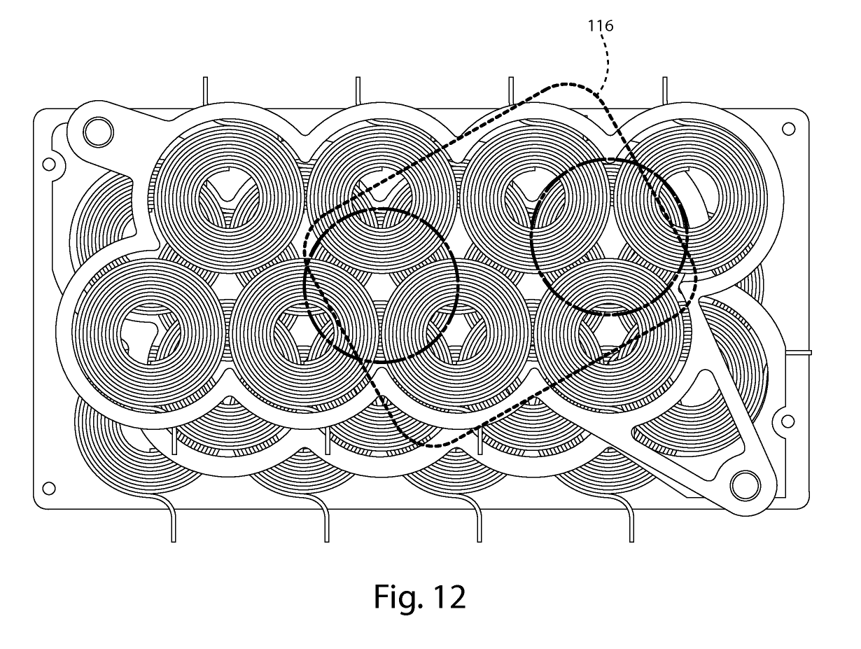

In another embodiment, the one or more resonators are located remote from the one or more inductive power transmitters such that the coupling ratio between the one or more resonators and the one or more inductive power transmitters is substantially reduced. For example, as shown in FIG. 11, a resonator may be located sufficiently remotely from the inductive power transmitter such that when the inductive power transmitter is driven, little to no current is produced in the resonator. The inductive power transmitter can produce a change in current in the remote resonator by placing an inductive power receiver 116 as shown in FIG. 12 so that the inductive power receiver can couple to both the inductive power transmitter and to the remote resonator.

In another embodiment, the one or more resonators are shielded from the one or more inductive power transmitters. In order for the inductive power transmitter to produce a change in current in the remote resonator, the inductive power receiver couples to both the inductive power transmitter and to the remote resonator. That is, the resonator is shielded from the inductive power transmitter, but not from the inductive power receiver.

Referring back to FIG. 2, when an inductive power transmitter is powered with an alternating current in the absence of an inductive power receiver, little to no current is induced in the adjacent resonators. However, when an inductive power receiver is placed on the array of coils and the inductive power transmitter is powered using an alternating current, alternating current is induced in the inductive power receiver and the alternating current induced in the inductive power receiver in turn induces current in any resonators that the inductive power receiver is coupled with. By measuring the current or other characteristics of power induced in the resonators, the inductive charger can determine if a device has been placed on the array and can also characterize the device. For example, if an inductive power receiver is placed directly over the inductive power transmitter, the current induced in the adjacent resonators increases, but not by a substantial amount. However, if the inductive power receiver is placed directly over a resonator, the induced current increases in that resonator by a relatively substantial amount. Accordingly, by analyzing the sensor output, the inductive charger can determine if an inductive power receiver has been placed in proximity to a resonator and can characterize the device.

Characteristics of power that can be measured by a resonator sensor can include current, voltage, power, or any other characteristic of power. The measurements can be the magnitude, phase, average value, peak value, root mean square value, or any other type of measurement of a characteristic of power.

The type of characterization and the accuracy of the characterization can vary widely from application to application. In some embodiments, precise coordinates, orientation, pitch, yaw, and dimensions of the inductive power receiver can be determined based on the information collected from the resonators. In alternative embodiments, general positioning and boundaries of the device may be determined. In general, the more resonator sensor output available, the more precise the characterization can be. Although the information collected from the resonators can be helpful in characterizing the inductive power receiver, it may also be useful in characterizing the secondary device itself.

In embodiments where a more accurate characterization is desired, additional techniques can be utilized to increase resolution. For example, triangulation may be utilized to determine the position utilizing additional data points from additional resonators. Or, in other circumstances, the coil geometry information may be utilized to assist with the characterization. In one embodiment, the characterization process can account for the vertical distance between the layers in a multi-layer coil array so that information from resonators in different layers can be compared more easily. In other embodiments, the vertical distance between resonators in different layers does not have an appreciable effect on the results of a ping and can be ignored.

In addition to information gathered from resonator sensors, additional information can be obtained from the inductive power transmitter, elsewhere in the primary circuitry, or from the secondary device itself. This information can be utilized in conjunction with the resonator information to characterize the inductive power receiver, or, alternatively, the information can be utilized to verify a characterization of the inductive power receiver based on the resonator information. For example, information can be obtained by sensing a characteristic of power in the inductive power transmitter, such as current, voltage, or power. Just as with the resonator sensors, the measurements can be magnitude, phase, average value, peak value, root mean square value, or any other type of measurement of a characteristic of power.

Other factors besides positioning can also be taken into account during this process. For example, if the remote device connected to the inductive power receiver requires more power than one inductive power transmitter could provide, then additional inductive power transmitters may be utilized to increase the total amount of power delivered to the load. Or, if there is a parasitic load, such as a piece of metal located on the charging surface, the controller may identify the parasitic load and then choose to activate coils farther away from the parasitic load, but still able to provide power to the inductive power receiver. These are just two examples of other information that can be factored into the decision about which coils to activate in the coil array.

The system can utilize position information to determine which coils and how many coils to energize in order to transfer power to the secondary device. By turning on different combination of coils as inductive power transmitters, the position of the magnetic field can be shifted around the charging surface.

In order to detect or characterize an inductive power receiver, the controller can be programmed to energize an inductive power transmitter for a short period of time. In alternative embodiments, multiple inductive power transmitters can be simultaneously energized for a short period of time. Sensors can then be used to determine whether an inductive power receiver is present and if an inductive power receiver is in the vicinity, where the inductive power receiver is positioned. In this way, by energizing an inductive power transmitter, an inductive power receiver can be detected that is in proximity to either the inductive power transmitter or any of the selected resonators. Because the coupling ratio between the inductive power transmitter and the resonators is reduced, when the inductive power transmitter is driven in the absence of an inductive power receiver, little to no current will be induced in the resonators. However, when an inductive power receiver is placed in a position where it couples to both the inductive power transmitter and a resonator, current will be induced in the resonator. That is, alternating current in the inductive power transmitter induces current in the inductive power receiver, which in turn induces current in the resonator, even though the resonator is not directly coupled to the inductive power transmitter.

Alternatively, the remote device may activate its coil and transfer small amounts of energy from the remote device to the inductive power supply. The inductive power supply may read the characteristics of power in both the power transmitting coil or the resonating coils or both. Once the inductive power supply detects power is being applied to coils, it uses the sensor information in the same manner to detect the location and characteristics of the remote device. The remote device may be configured to communicate with the inductive power supply through a separate communication channel to determine when it may be close enough to begin applying power to its coil. Alternatively, the remote device may be configured with a user input such that a user may prompt the remote device to apply power to its coil.

In one embodiment, when an inductive power transmitter is energized, the reflected impedance from the secondary load can be sensed using a sensor in the inductive power transmitter. For example, a current sensor in the inductive power transmitter will show that the current changes as a function of whether or not a secondary coil is present and the distance of the secondary coil from the resonator. This process can be referred to as pinging. During pinging, information can also be collected from sensors in one or more resonators. For example, information can be collected from sensors in adjacent resonators, which provides information about a larger area of the charging surface than the sensor in the inductive power transmitter can provide. Accordingly, by utilizing resonators, multiple data points can be obtained from a single ping that can be utilized to quickly detect and characterize the inductive power receiver. For example, from a single ping it may be possible for the system to locate the precise position, size, and shape of the inductive power receiver.

In one embodiment, the method for searching a charging surface of a coil array for an inductive power receiver includes configuring a coil array so that one coil is an inductive power transmitter and a plurality of other coils in the array are resonators, pinging with the inductive power transmitter including collecting information from sensors associated with each of the resonators, and in response to the information either 1) reconfiguring the array so that a different coil is an inductive power transmitter and a different plurality of coils in the array are resonators, or 2) characterizing the inductive power receiver based on the information, configuring one or more coils in the array to be inductive power transmitters based on the characterization, and supplying power to the inductive power receiver. In this way, a single ping can be used to search not only the area proximate to the inductive power transmitter, but also the area proximate to the resonators.

Referring back to FIG. 4, the inductive charger includes a multiplexer that connects coils to either a half bridge driver, a reference voltage (in this case ground), or leaves them as an open circuit. When a coil is selected and connected to the reference voltage, this circuit becomes a resonating circuit. In the FIG. 4 embodiment, each coil has an individual sensor 400, 402, 404 so that when that coil is connected as a resonator or an inductive power transmitter, it can provide information about the inductive power receiver.

Referring to FIG. 5, in this embodiment, coils are still selected using a multiplexer and can still be connected either to either a half bridge driver or to a reference voltage, such as ground. However, in this embodiment, a current sensor 500, 502 is placed between the multiplexer and the driver, and between the multiplexer and the reference voltage. In configurations where there is only one resonator, this configuration provides a lower cost and simpler configuration. Where a predefined number of resonators will be used that is less than the number of coils in a selectable array, the current sensors can be provided based on the multiplexer connections instead of providing an individual current sensor for each coil.

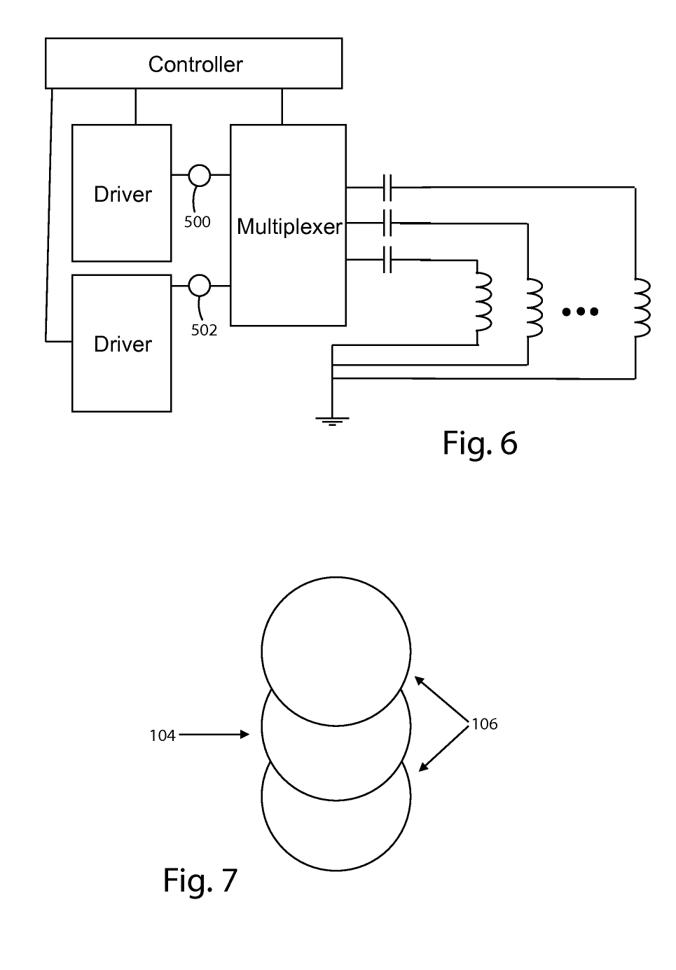

Referring to FIG. 6, in this embodiment two or more half bridge drivers can be utilized instead of just one. To configure coils in the array as resonating coils, one field effect transistor of the half bridge driver can be turned and left on so that multiplexer connections to that driver result in connecting the coil to a reference voltage (either +V or ground in this case). This allows a second driver to be selectively configured to be used as a reference voltage or as driver when having multiple drivers is advantageous, for example where there are two inductive power receivers that simultaneously desire power. Although the illustrated embodiment depicts two drivers, additional drivers could be added to provide the ability to power even more inductive power receivers simultaneously. The additional drivers could also be configured such that additional coils connected via the multiplexer are resonators. In an alternative embodiment, the multiplexer may connect the coils to multiple drivers and to one or more reference voltages. In this way the inductive charger could be dynamically configured to dynamically provide more resonators or more inductively powered transmitters, depending on the application at hand.

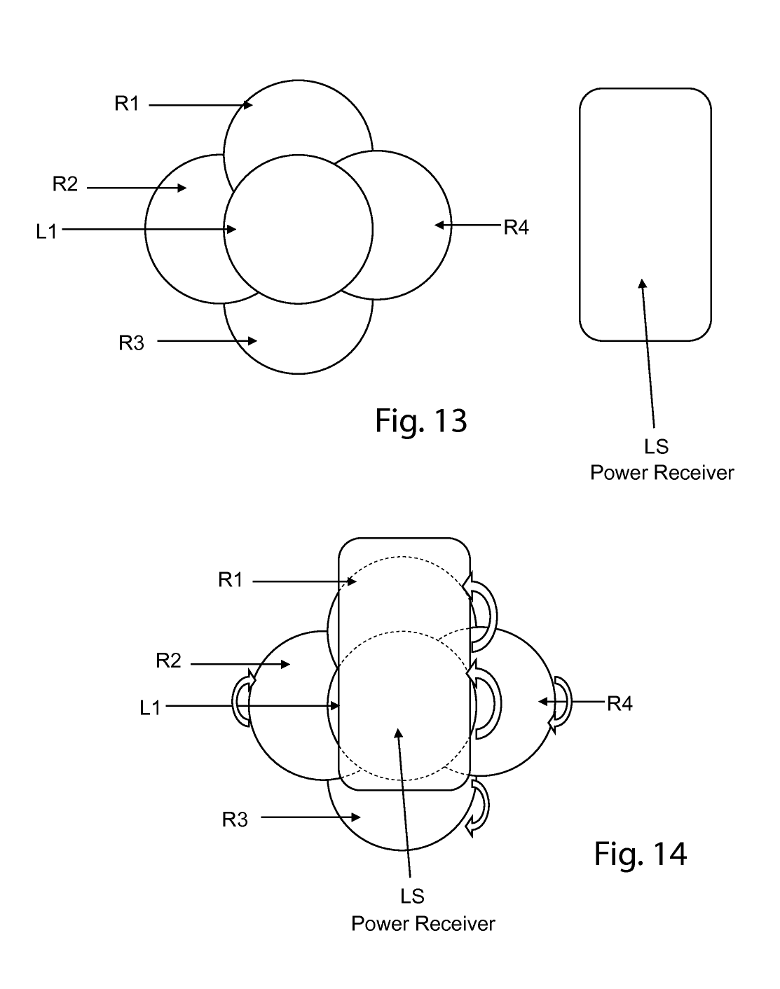

As mentioned above, FIG. 7 illustrates a three coil array. Similar to the larger array illustrated in FIG. 2, the FIG. 7 array is arranged such that each coil is offset by one radius length and arranged in a stacked configuration directly on top of one another. In the current embodiment, the center coil is configured as an inductive power transmitter and the two outer coils are configured as resonators. When a receiver is placed on the array at an offset (as shown in FIG. 9), it becomes coupled to both the powered transmitting coil and the upper resonating coil. The secondary also becomes negatively coupled to the lower resonating coil. The absolute value of the coupling ratio to the lower coil is less than the absolute value of the coupling ratio between the inductive power receiver and the upper resonating coil. By observing a characteristic of power (such as current) in all three coils, including the amplitude and phase, the device location can be determined. FIG. 13 shows an alternative embodiment with an inductive power transmitter, receiver, and four dedicated resonators. FIG. 14 shows exemplary phase relationships between the transmitter and the four resonators.

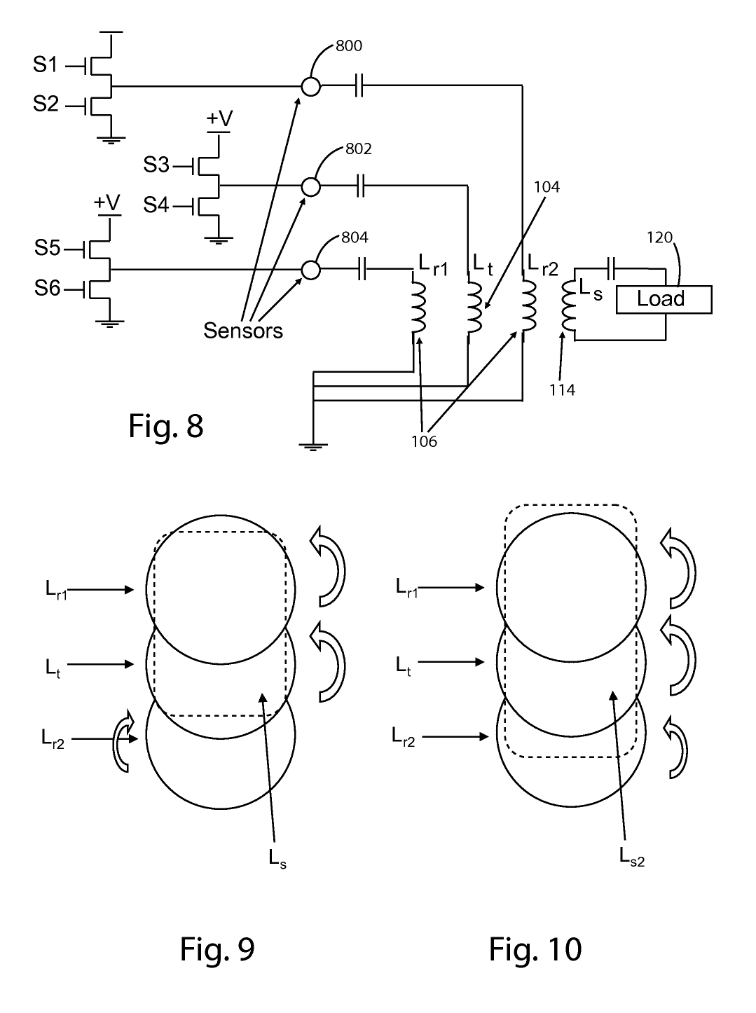

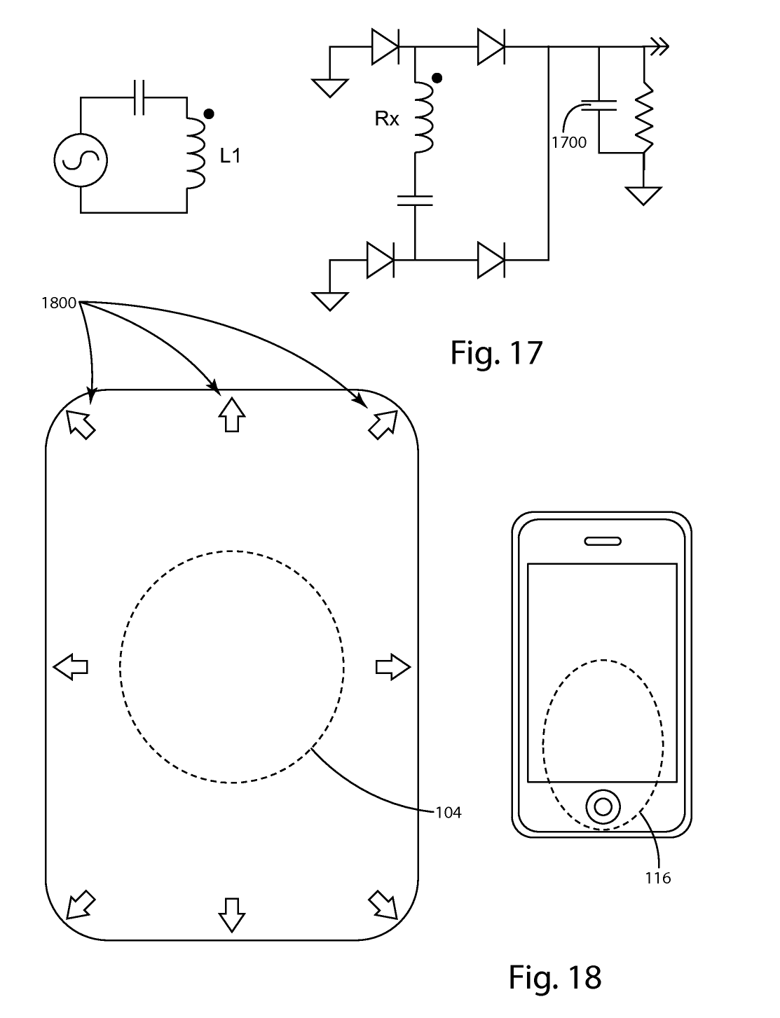

FIG. 8 depicts one embodiment of a portion of a circuit diagram for an inductive charger such as the one illustrated in FIG. 7. In this embodiment, rather than using a multiplexer, three half bridge drivers, each dedicated to one coil are provided. To configure the two outer coils as resonating coils, switches S2 and S4 are turned on. In this configuration, the resonant frequencies of each circuit (inductive power transmitter, resonators, and the inductive power receiver) are tuned to the same frequency. This allows the inductive power supply to apply a small amount of power for a short time period and still induce current in the inductive power receiver (and resonators). Alternatively, circuits can be tuned to two or more different resonant frequencies. In such a configuration, sensor measurements may substantially vary in inductive power transmitters and resonators, even if the inductive power receiver is coupled the same to each. These variations can be accounted for in the detection or characterizing process. The inductive charger measures the amplitude of the inductive power transmitter (the amplitude typically goes down in the presence of the secondary), and the amplitude and phase of each of the resonators using the sensors 800, 802, 804. This information can be stored in memory. The information can be analyzed to detect, characterize, and track the inductive power receiver. Alternatively or in addition, the inductive power transmitter can be powered long enough to power up the secondary load and begin receiving communications. FIG. 17 shows an alternate schematic of a secondary device with a single resonator, wherein a series resonant capacitor 1700 is provided to enhance performance.

By way of example, FIG. 9 illustrates a three coil array with an inductive power receiver Lₛ placed covering one of the resonators Lᵣ₁ and covering the inductive power supply transmitter Lₜ. The inductive power transmitter Lₜ can be pinged and the responses to the ping from the sensors in the resonators Lᵣ₁, Lᵣ₂ and from the sensor in the inductive power transmitter Lₜ can be stored in memory. Given the position of the secondary device in FIG. 9, the response to the ping for resonator Lᵣ₁ will be relatively higher than the response to the ping for Lᵣ₂ because the inductive power receiver is more closely aligned with resonator Lᵣ₁ than it is with resonator Lᵣ₂. The response to the ping for the sensor in the inductive power transmitter Lₜ will be relatively similar to the response to the ping for the resonator Lᵣ₁ because the inductive power receiver Lₛ covers about the same amount of area of the resonator Lᵣ₁ as it does of the inductive power transmitter Lₜ. There can be some expected differences in the ping responses, for example due to being a resonator or a inductive power transmitter or due to the Z position of the coil, however those differences can be accounted for in the process. In this scenario, the system can determine that both the inductive power transmitter Lₜ and the resonator Lᵣ₁ are equally coupled to the receiver and that the inductive power receiver Lₛ does not extend over top of the resonator Lᵣ₂.

Determining the position of an inductive power receiver based on the resonator information can be accomplished in a variety of ways. For example, the relative sensor measurements can be utilized to provide a fairly accurate portrayal of the position of the inductive power receiver. The higher the relative value of the measurement, the closer that resonator is to the inductive power receiver. In an alternative embodiment, each sensor measurement can be compared against a threshold value. If the sensor measurement is above the threshold value, the inductive power receiver may be deemed close enough to that resonator such that it can be configured as an inductive power transmitter. The threshold can vary from application to application and from coil to coil. The threshold can be set at manufacture or dynamically changed based on information collected by the inductive charger during use, either through use of the sensors or in some embodiments via information received through a communication system. In another embodiment, a combination of the relative measurements and thresholds may be utilized to characterize the inductive power receiver. Where the position of the inductive power receiver cannot be positively located, the measurements in the resonator can be utilized to determine which coil or coils should be resonators and inductive power transmitters next. For example, where the measurement in all the resonators except two are near zero and there is a low measurement in the other two resonators, the controller can configure coils in the direction of the resonators with low measurements to be inductive power transmitters and resonators. In this way, it my be possible to quickly detect and characterize the inductive power receiver.

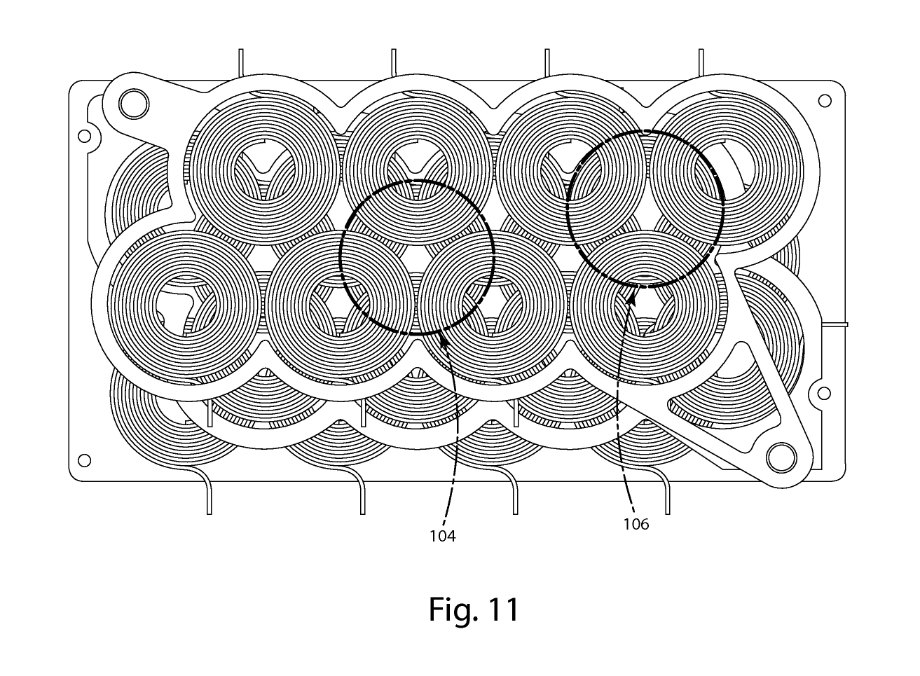

As a contrasting example, FIG. 10 illustrates a three coil array with an inductive power receiver Lₛ₂ placed covering one of the resonators Lᵣ₁, covering the inductive power supply transmitter Lₜ, and covering a portion of the other resonator Lᵣ₂. The inductive power transmitter Lₜ can be pinged and the responses to the ping from the sensors in the resonators Lᵣ₁, Lᵣ₂ and from the sensor in the inductive power transmitter Lₜ can be stored in memory. Given the position of the secondary device in FIG. 10, the response to the ping for resonator Lᵣ₁ will be relatively higher than the response to the ping for Lᵣ₂ because the inductive power receiver is more closely aligned with resonator Lᵣ₁ than it is with resonator Lᵣ₂. Just as with the FIG. 9 example, the response to the ping for the sensor in the inductive power transmitter Lₜ will be relatively similar to the response to the ping for the resonator Lᵣ₁ because the inductive power receiver Lₛ covers about the same amount of area of the resonator Lᵣ₁ as it does of the inductive power transmitter L. The response to the ping for the resonator Lᵣ₂ in FIG. 9 and the response to the ping for the resonator Lᵣ₂ in FIG. 10 may be similar, despite the fact that in one example the inductive power receiver is generally adjacent to the resonator Lᵣ₂ (FIG. 9) and in the other example the inductive power receiver is generally overlapping the resonator Lᵣ₂ (FIG. 10). This can be explained by the coupling ratio in each example. In FIG. 9, the coupling ratio is positive, but in FIG. 10 the coupling ratio is negative. Because the magnitude measurement of the current does not account for the sign of the coupling ratio, in some circumstances the magnitude is insufficient to determine whether the size of the inductive power receiver. However, by measuring the phase of the resonators, the coupling ratio can be determined, and the controller can determine if the inductive power receiver is just smaller and is adjacent to the resonator like in FIG. 9, or if the inductive power receiver is covering a portion of the resonator like in FIG. 10.

The above description is that of current embodiments of the invention. Various alterations and changes can be made without departing from the spirit and broader aspects of the invention as defined in the appended claims, which are to be interpreted in accordance with the principles of patent law including the doctrine of equivalents. Any reference to claim elements in the singular, for example, using the articles “a,” “an,” “the” or “said,” is not to be construed as limiting the element to the singular.

The embodiments of the invention in which an exclusive property or privilege is claimed are defined as follows:

1. An inductive charger for detecting the position of an inductive power receiver proximate to an inductive charging surface, said inductive charger comprising:
one or more resonators;
one or more drivable inductive power transmitters for transferring power to an inductive power receiver located proximate to said inductive charging surface, where said inductive charger is configured such that coupling between said one or more resonators and said one or more inductive power transmitters is substantially reduced; and
one or more resonator sensors, each generating sensor output indicative of a characteristic of power in said one or more resonators.

2. The inductive charger of claim 1 wherein
each of said one or more resonators configured such that
driving said one or more inductive power transmitters in the presence of an inductive power receiver produces sensor output change in at least one of said one or more sensors in comparison to a reference created by driving said one or more inductive power transmitters in the absence of an inductive power receiver.

3. The inductive charger of claim 1 wherein said coupling is substantially reduced by having said one or more resonators offset from said one or more inductive power transmitters such that a coupling ratio between said one or more resonators and said one or more inductive power transmitters is below a predetermined coupling ratio threshold.

4. The inductive charger of claim 1 wherein said coupling is substantially reduced by having said one or more resonators located remote from said one or more inductive power transmitters such that a coupling ratio between said one or more resonators and said one or more inductive power transmitters is below a predetermined coupling ratio threshold.

5. The inductive charger of claim 1 wherein said coupling is substantially reduced by having said one or more resonators shielded from said one or more inductive power transmitters such that the coupling ratio between said one or more resonators and said one or more inductive power transmitters is below a predetermined coupling ratio threshold.

6. The inductive charger of claim 1 wherein each of said one or more resonators is at least one of offset from said one or more power transmitters, positioned remotely from said one or more power transmitters, and shielded from said one or more power transmitters such that the coupling ratio between said one or more resonators and said one or more inductive power transmitters is below a predetermined coupling ratio threshold.

7. The inductive charger of claim 1 including one or more power transmitter sensors, each generating power transmitter sensor output indicative of a characteristic of power in said one or more power transmitters,
wherein driving said one or more inductive power transmitters in the presence of a conductive object produces a power transmitter sensor output change above a threshold in at least one of said one or more power transmitter sensors and produces a stable sensor output below a threshold in each of said one or more resonator sensors,
whereby a combination of said power transmitter sensor output and said resonator sensor output is indicative of at least one of presence of an inductive power receiver, presence of metal, and presence of an inductive power receiver and metal.

8. The inductive charger of claim 1 wherein each of said one or more sensors generates sensor output indicative of a magnitude of a characteristic of power in said resonator that is indicative of position of an inductive power receiver.

9. The inductive charger of claim 1 wherein each of said one or more sensors generates sensor output indicative of a phase of a characteristic of power in said resonator that is indicative of position of an inductive power receiver.

10. The inductive charger of claim 8 wherein said phase of said characteristic of power is indicative of whether an inductive power receiver is at least one of adjacent and overlapping said one or more resonators.

11. The inductive charger of claim 1 including a plurality of selectively configurable inductors wherein each of said selectively configurable inductors is selectively configurable to be at least one of said one or more power transmitters, one of said one or more resonators, and an open circuit.

12. The inductive charger of claim 11 in response to determining the position of an inductive power receiver, one of said plurality of selectively configurable inductors near the position of the inductive power receiver is configured as a power transmitter.

13. The inductive charger of claim 1 including a plurality of inductors wherein each of said inductors is fixed as either one of said one or more power transmitters or one of said one or more resonators.

14. The inductive charger of claim 1 including a display on the inductive charger to display alignment information to a user.

15. The inductive charger of claim 1 including a communication channel for providing alignment information to a remote device to be displayed on said remote device.

16. An inductive charging system for detecting the position of an inductive power receiver proximate to an inductive charger, said inductive charging system comprising:
an inductive power receiver including
a first drivable inductive power transmitter for transmitting power from said inductive power receiver to said inductive charger;
an inductive power receiver for receiving power from an inductive charger;
an inductive charger including
one or more resonators;
a second drivable inductive power transmitter for transferring power to said inductive power receiver located proximate to said inductive charging surface, where said inductive charger is configured such that coupling between said one or more resonators and said one or more inductive power transmitters is substantially reduced; and
one or more sensors, each generating sensor output indicative of a characteristic of power in said one or more resonators;

17. The inductive charging system of claim 16 wherein each of said one or more resonators are configured such that power received from said inductive power receiver produces a sensor output change in at least one of said one or more sensors in comparison to a threshold.

18. The inductive charging system of claim 16 wherein said coupling is substantially reduced by having said one or more resonators offset from said second drivable inductive power transmitter such that a coupling ratio between said one or more resonators and said second inductive power transmitter is below a predetermined coupling ratio threshold.

19. The inductive charging system of claim 16 wherein said coupling is substantially reduced by having said one or more resonators located remote from said second drivable inductive power transmitter such that a coupling ratio between said one or more resonators and said second inductive power transmitter is below a predetermined coupling ratio threshold.

20. The inductive charging system of claim 16 wherein said coupling is substantially reduced by having said one or more resonators shielded from said one or more inductive charger inductive power transmitters such that a coupling ratio between said one or more resonators and said one or more inductive power transmitters is below a predetermined coupling ratio threshold.

21. The inductive charging system of claim 16 wherein each of said one or more resonators is at least one of offset from said one or more inductive charger power transmitters, positioned remotely from said one or more inductive charger power transmitters, and shielded from said one or more inductive charger power transmitters such that a coupling ratio between said one or more resonators and said one or more inductive power transmitters is below a predetermined coupling ratio threshold.

22. The inductive charging system of claim 16 wherein each of said one or more sensors generates sensor output indicative of a magnitude of a characteristic of power in said resonator that is indicative of position of an inductive power receiver.

23. The inductive charging system of claim 16 wherein each of said one or more sensors generates sensor output indicative of a phase of a characteristic of power in said resonator that is indicative of position of an inductive power receiver.

24. The inductive charging system of claim 22 wherein said phase of said characteristic of power is indicative of whether an inductive power receiver is at least one of adjacent and overlapping said one or more resonators.

25. The inductive charging system of claim 16 including a plurality of selectively configurable inductors wherein each of said selectively configurable inductors is selectively configurable to be at least one of said one or more power transmitters, one of said one or more resonators, and an open circuit.

26. The inductive charging system of claim 24 in response to determining the position of an inductive power receiver, one of said plurality of selectively configurable inductors near the position of the inductive power receiver is configured as a power transmitter.

27. The inductive charger of claim 16 including a plurality of inductors wherein each of said inductors is fixed as either one of said one or more power transmitters or one of said one or more resonators.

28. The inductive charger of claim 16 including a display on the inductive charger to display alignment information to a user.

29. The inductive charger of claim 16 including a communication channel for providing alignment information to a remote device to be displayed on said remote device.

30. An inductive charging system comprising:
a remote device having:
one or more inductive power receivers;
an inductive charger having:
one or more resonators;
one or more drivable inductive power transmitters for transferring power to said inductive power receiver located proximate to said inductive charger, where said inductive charger is configured to reduce coupling between said one or more resonators and said one or more inductive power transmitters without substantially altering coupling between said inductive power receiver and said one or more inductive power transmitters when said remote device is positioned proximate to said inductive charger.

31. The inductive charging system of claim 29 including one or more sensors, each generating sensor output indicative of a characteristic of power in said one or more resonators.

32. The inductive charging system of claim 29 wherein each of said one or more resonators are configured such that
driving said one or more inductive power transmitters in the presence of an inductive power receiver produces sensor output change in at least one of said one or more sensors in comparison to a reference created by driving said one or more inductive power transmitters in the absence of an inductive power receiver.

33. The inductive charging system of claim 29 wherein said coupling is reduced by having said one or more resonators offset from said one or more inductive power transmitters such that a coupling ratio between said one or more resonators and said one or more inductive power transmitters is below a predetermined coupling ratio threshold.

34. The inductive charging system of claim 29 wherein said coupling is reduced by having said one or more resonators located remote from said one or more inductive power transmitters such that a coupling ratio between said one or more resonators and said one or more inductive power transmitters is below a predetermined coupling ratio threshold.

35. The inductive charging system of claim 29 wherein said coupling is substantially reduced by having said one or more resonators shielded from said one or more inductive power transmitters such that a coupling ratio between said one or more resonators and said one or more inductive power transmitters is below a predetermined coupling ratio threshold.

36. The inductive charging system of claim 29 wherein each of said one or more resonators is at least one of offset from said one or more power transmitters, positioned remotely from said one or more power transmitters, and shielded from said one or more power transmitters such that the coupling ratio between said one or more resonators and said one or more inductive power transmitters is below a predetermined coupling ratio threshold.

37. The inductive charging system of claim 29 including one or more power transmitter sensors, each generating power transmitter sensor output indicative of a characteristic of power in said one or more power transmitters,
wherein driving said one or more inductive power transmitters in the presence of metal produces a power transmitter sensor output change above a threshold in at least one of said one or more power transmitter sensors and produces a stable sensor output below a threshold in each of said one or more resonator sensors,
whereby a combination of said power transmitter sensor output and said resonator sensor output is indicative of at least one of presence of an inductive power receiver, presence of metal, and presence of an inductive power receiver and metal.

38. The inductive charging system of claim 30 wherein each of said one or more sensors generates sensor output indicative of a magnitude of a characteristic of power in said resonator that is indicative of position of an inductive power receiver.

39. The inductive charging system of claim 30 wherein each of said one or more sensors generates sensor output indicative of a phase of a characteristic of power in said resonator that is indicative of position of an inductive power receiver.

40. The inductive charging system of claim 38 wherein said phase of said characteristic of power is indicative of whether an inductive power receiver is at least one of adjacent and overlapping said one or more resonators.

41. The inductive charging system of claim 29 including a plurality of selectively configurable inductors wherein each of said selectively configurable inductors is selectively configurable to be at least one of said one or more power transmitters, one of said one or more resonators, and an open circuit.

42. The inductive charging system of claim 29 in response to determining the position of an inductive power receiver, one of said plurality of selectively configurable inductors near the position of the inductive power receiver is configured as a power transmitter.

43. The inductive charging system of claim 29 including a plurality of inductors wherein each of said inductors is fixed as either one of said one or more power transmitters or one of said one or more resonators.

44. The inductive charging system of claim 29 including a display on the inductive charger to display alignment information to a user.

45. The inductive charging system of claim 29 including a communication channel for providing alignment information to said remote device, said remote device including a display to display alignment information to a user.

46. The inductive charging system of claim 29 wherein said remote device is configured to supply power from the one or more coils located within the remote device to the charging base.

47. The inductive charging system of claim 45 wherein the charging base is configured to determine the location of the remote device by detecting the magnitude of the output of the resonator sensors.

48. The inductive charging system of claim 29 wherein the resonators are coupled to an LED display wherein current coupled into the said one or more resonators from the mutual coupling to the remote device causes the one or more LEDs to light up

49. The inductive charging system of claim 47 wherein the LEDs are configured into a display of guide arrows to provide alignment information to the user.

50. The inductive charging system of claim 48 wherein the LED array is configured such that the resonator located on one side of the coil provides coupled current to an LED located on the opposite side of the array.
